(19) United States
(12) Patent Application Publication
(10) Pub. No.: US 2022/0203517 A1
(43) Pub. Date: Jun. 30, 2022

(54) NON-TRANSITORY STORAGE MEDIUM AND METHOD AND SYSTEM OF CREATING CONTROL PROGRAM FOR ROBOT

(71) Applicant: SEIKO EPSON CORPORATION, Tokyo (JP)

(72) Inventors: Yuma IWAHARA, MATSUMOTO-SHI (JP); Takayuki KITAZAWA, SUWA-SHI (JP)

(21) Appl. No.: 17/560,280

(22) Filed: Dec. 23, 2021

(30) Foreign Application Priority Data
Dec. 24, 2020 (JP) 2020-214761

(51) Int. Cl. B25J 9/00; B25J 9/16; B25J 19/02; G06V 40/20; G06V 40/10; G06V 20/40; G06V 10/82; G06T 7/70

(52) U.S. Cl. CPC B25J 9/0081; B25J 9/1612; B25J 9/1697; B25J 19/023; G06V 40/28; G06T 2207/30164; G06V 20/46; G06V 10/82; G06T 7/70; G06T 2207/20084; G06V 40/10

(57) ABSTRACT

A non-transitory computer-readable storage medium storing a computer program controls a processor to execute (a) processing of recognizing a worker motion from an image of one or more worker motions captured by an imaging apparatus, (b) processing of recognizing hand and finger positions in a specific hand and finger motion when the worker motion contains the specific hand and finger motion, (c) processing of recognizing a position of a workpiece after work, and (d) processing of generating a control program for a robot using the worker motion, the hand and finger positions, and the position of the workpiece.

The present application is based on, and claims priority from JP Application Serial Number 2020-214761, filed Dec. 24, 2020, the disclosure of which is hereby incorporated by reference herein in its entirety.

### BACKGROUND

### 1. Technical Field

The present disclosure relates to a non-transitory storage medium and a method and a system of creating a control program for a robot.

### 2. Related Art

JP-A-2011-110621 discloses a technique of creating teaching data for a robot. In the related art, a teaching image containing a hand of a worker is acquired using a camera, hand and finger coordinates as positions of respective joints of a hand and fingers and finger tips are determined based on the teaching image, and a motion of a robot arm 110 is taught based on the hand and finger coordinates.

However, in the related art, the hand and fingers are recognized on a regular basis even when not gripping or releasing an object, and there is a problem that the processing load is heavy.

### SUMMARY

According to a first aspect of the present disclosure, a computer program for a processor to execute processing of creating a control program for a robot is provided. The computer program controls the processor to execute (a) processing of recognizing a worker motion from an image of one or more worker motions contained in work to operate a workpiece by a worker using an arm and a hand and fingers, the image captured by an imaging apparatus, (b) processing of recognizing hand and finger positions in a specific hand and finger motion with motion of joints of the hand and fingers from an image of the hand and fingers captured by the imaging apparatus when the worker motion contains the specific hand and finger motion, (c) processing of recognizing a position of the workpiece after the work from an image of the workpiece captured by the imaging apparatus, and (d) processing of generating the control program for the robot using the worker motion recognized in the processing (a), the hand and finger positions recognized in the processing (b), and the position of the workpiece recognized in the processing (c).

According to a second aspect of the present disclosure, a method of creating a control program for a robot is provided. The method includes (a) recognizing a worker motion from an image of one or more worker motions contained in work to operate a workpiece by a worker using an arm and a hand and fingers, the image captured by an imaging apparatus, (b) recognizing hand and finger positions in a specific hand and finger motion with motion of joints of the hand and fingers from an image of the hand and fingers captured by the imaging apparatus when the worker motion contains the specific hand and finger motion, (c) recognizing a position of the workpiece after the work from an image of the workpiece captured by the imaging apparatus, and (d) generating the control program for the robot using the worker motion recognized at (a), the hand and finger positions recognized at (b), and the position of the workpiece recognized at (c).

According to a third aspect of the present disclosure, a system executing processing of creating a control program for a robot is provided. The system includes an information processing apparatus having a processor, and an imaging apparatus coupled to the information processing apparatus. The processor executes (a) processing of recognizing a worker motion from an image of one or more worker motions contained in work to operate a workpiece by a worker using an arm and a hand and fingers, the image captured by the imaging apparatus, (b) processing of recognizing hand and finger positions in a specific hand and finger motion with motion of joints of the hand and fingers from an image of the hand and fingers captured by the imaging apparatus when the worker motion contains the specific hand and finger motion, (c) processing of recognizing a position of the workpiece after the work from an image of the workpiece captured by the imaging apparatus, and (d) processing of generating the control program for the robot using the worker motion recognized in the processing (a), the hand and finger positions recognized in the processing (b), and the position of the workpiece recognized in the processing (c).

### BRIEF DESCRIPTION OF THE DRAWINGS

FIG. 1 is an explanatory diagram of a robot system in an embodiment.

FIG. 2 is a functional block diagram of an information processing apparatus.

FIG. 3 is a flowchart showing a procedure of control program creation processing.

FIG. 4 is an explanatory diagram showing an example of image frames obtained by imaging of workpieces within a first work area.

FIG. 5 is an explanatory diagram showing recognition results of workpieces.

FIG. 6 is an explanatory diagram showing an example of image frames obtained by imaging of worker motions.

FIG. 7 is an explanatory diagram showing recognition results of worker motions.

FIG. 8 is a flowchart showing a detailed procedure at step S40.

FIG. 9 is an explanatory diagram showing recognition of hand and finger positions.

FIG. 10 is an explanatory diagram showing hand and finger positions to be recognized.

FIG. 11 is an explanatory diagram showing recognition results of the hand and finger positions.

FIG. 12 is an explanatory diagram showing a work description list.

### DESCRIPTION OF EXEMPLARY EMBODIMENTS

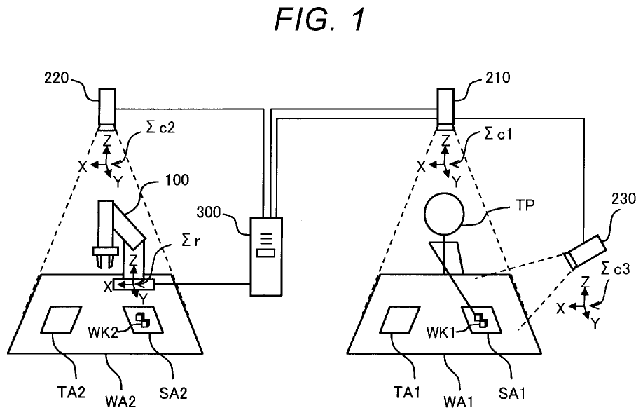

FIG. 1 is an explanatory diagram showing an example of a robot system in one embodiment. The robot system includes a robot 100, a first camera 210, a second camera 220, a third camera 230, and an information processing apparatus 300 having functions of controlling the robot 100. The information processing apparatus 300 is e.g. a personal computer.

The robot 100 is a multi-axis robot having a plurality of joints. As the robot 100, a robot having any arm mechanism having one or more joints can be used. The robot 100 of the embodiment is a vertical articulated robot, however, a horizontal articulated robot may be used. In the embodiment, the end effector of the robot 100 is a gripper that may hold a workpiece, however, any end effector can be used.

In the robot system in FIG. 1, a first work area WA1 in which a worker TP performs teaching work and a second work area WA2 in which the robot 100 executes work are set. The worker TP is also referred to as “teacher”. The first work area WA1 can be imaged by the first camera 210. The second work area WA2 can be imaged by the second camera 220. It is preferable that the relative position between the first work area WA1 and the first camera 210 is set to be the same as the relative position between the second work area WA2 and the second camera 220. Note that the first work area WA1 and the second work area WA2 may be the same area.

In the first work area WA1, the third camera 230 for imaging a hand and fingers of the worker TP and a workpiece is placed. It is preferable that the third camera 230 is placed in a position closer to the first work area WA1 than that of the first camera 210 for imaging the hand and fingers and the workpiece closer than the first camera 210. The positions of the hand and fingers and the workpiece are recognized using an image captured by the third camera 230, and thereby, the positions of the hand and fingers and the workpiece may be recognized more accurately compared to a case using only the first camera 210. Note that the third camera 230 may be omitted.

The first work area WA1 contains a first supply area SA1 and a first target area TA1. The first supply area SA1 is an area in which a workpiece WK1 is placed at the start of teaching work. The first target area TA1 is an area in which the workpiece WK1 moved from the first supply area SA1 is placed by operation by the worker TP as the teaching work. The shapes and positions of the first supply area SA1 and the first target area TA1 within the first work area WA1 can be arbitrarily set.

The second work area WA2 has the same shape as the first work area WA1, and contains a second supply area SA2 and a second target area TA2 having the same shapes as the first supply area SA1 and the first target area TA1, respectively. The second supply area SA2 is an area in which a workpiece WK2 is placed when work by the robot 100 is started. The second target area TA2 is an area in which the workpiece WK2 moved from the second supply area SA2 is placed by the work by the robot 100. Note that the supply areas SA1, SA2 and the target areas TA1, TA2 may be respectively realized using trays or the individual areas SA1, SA2, TA1, TA2 may be drawn by lines on a floor surface or a table. Or, the supply areas SA1, SA2 and the target areas TA1, TA2 are not necessarily explicitly partitioned.

The workpiece WK1 as a working object in the first work area WA1 and the workpiece WK2 as a working object in the second work area WA2 are the same type of objects having the same design. To make the correspondence relationship with the respective work areas WA1, WA2 clear, hereinafter, these are referred to as “first workpiece WK1” and “second workpiece WK2”.

In FIG. 1, a robot coordinate system Σr set for the robot 100, a first camera coordinate system Σc1 set for the first camera 210, a second camera coordinate system Σc2 set for the second camera 220, and a third camera coordinate system Σc3 set for the third camera 230 are drawn. All of these coordinate systems Σr, Σc1, Σc2, Σc3 are orthogonal coordinate systems defined by three axes X, Y, Z. The correspondence relationships among these coordinate systems Σr, Σc1, Σc2, Σc3 are determined by calibration.

The position and attitude of the workpiece WK1 and the motion of the worker TP in the first work area WA1 are recognized from the images of the first work area WA1 captured by the first camera 210 and the third camera 230 by the information processing apparatus 300. Further, the position and attitude of the workpiece WK2 in the second work area WA2 are recognized from the image of the second work area WA2 captured by the second camera 220 by the information processing apparatus 300. As the cameras 210, 220, 230, devices that may capture a subject in a moving image or a plurality of image frames are used. It is preferable that, as the cameras 210, 220, 230, devices that may three-dimensionally recognize a subject are used. As these cameras, e.g. stereo cameras or RGBD cameras that can shoot a color image and a depth image at the same time may be used. The RGBD cameras are used, and thereby, shapes of obstacles can be recognized using the depth images. The cameras 210, 220, 230 correspond to “imaging apparatus” in the present disclosure.

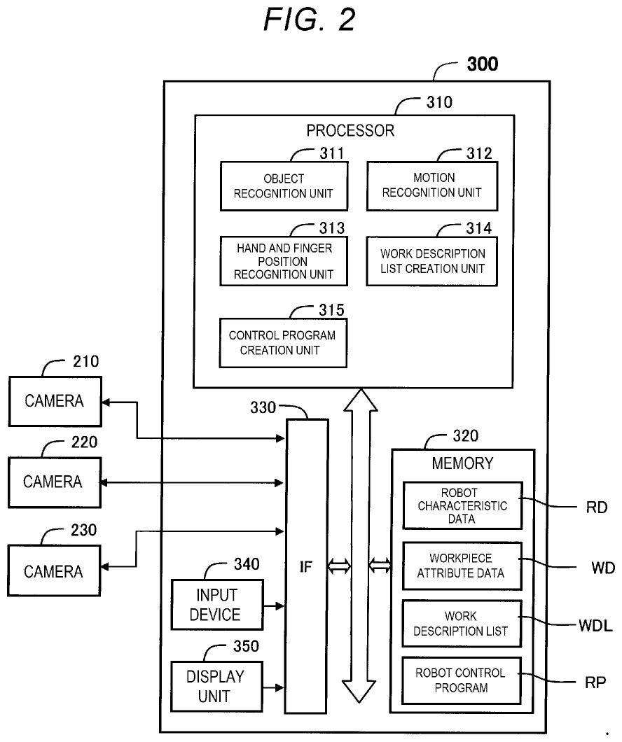

FIG. 2 is a block diagram showing functions of the information processing apparatus 300. The information processing apparatus 300 has a processor 310, a memory 320, an interface circuit 330, and an input device 340 and a display unit 350 coupled to the interface circuit 330. Further, the cameras 210, 220, 230 are coupled to the interface circuit 330.

The processor 310 has functions of an object recognition unit 311, a motion recognition unit 312, a hand and finger position recognition unit 313, a work description list creation unit 314, and a control program creation unit 315. The object recognition unit 311 recognizes the first workpiece WK1 from the image captured by the first camera 210 or the third camera 230 and recognizes the second workpiece WK2 from the image captured by the second camera 220. The motion recognition unit 312 recognizes the motion of the worker TP from the image captured by the first camera 210. The hand and finger position recognition unit 313 recognizes the hand and finger positions of the worker TP from the image captured by the first camera 210 or the third camera 230. The recognition by the object recognition unit 311, the motion recognition unit 312, and the hand and finger position recognition unit 313 may be realized using a machine learning model by deep learning and a feature quantity extraction model. The work description list creation unit 314 creates a work description list WDL, which will be described later, using recognition results of the other units. The control program creation unit 315 creates a control program for the robot 100 using the recognition results of the other units or the work description list WDL. These functions of the respective units 311 to 315 are realized by the processor 310 executing a computer program stored in the memory 320. Note that part or all of the functions of the respective units may be realized by a hardware circuit.

In the memory 320, robot characteristic data RD, workpiece attribute data WD, the work description list WDL, and a robot control program RP are stored. The robot characteristic data RD contains characteristics including the geometric structure, the rotatable angles of joints, the weight, and the inertial value of the robot 100. The workpiece attribute data WD contains attributes of the types, shapes, etc. of the workpieces WK1, WK2. The work description list WDL is data representing details of work recognized from the moving image or the plurality of image frames obtained by imaging of the motion of the worker TP and the first workpiece WK1 and describing work in a robot-independent coordinate system independent of the type of the robot. The robot control program RP includes a plurality of commands for moving the robot 100. For example, the robot control program RP is configured to control pick-and-place motion to move the second workpiece WK2 from the second supply area SA2 to the second target area TA2 using the robot 100. The robot characteristic data RD and the workpiece attribute data WD are prepared in advance before control program creation processing, which will be described later. The work description list WDL and the robot control program RP are created by the control program creation processing.

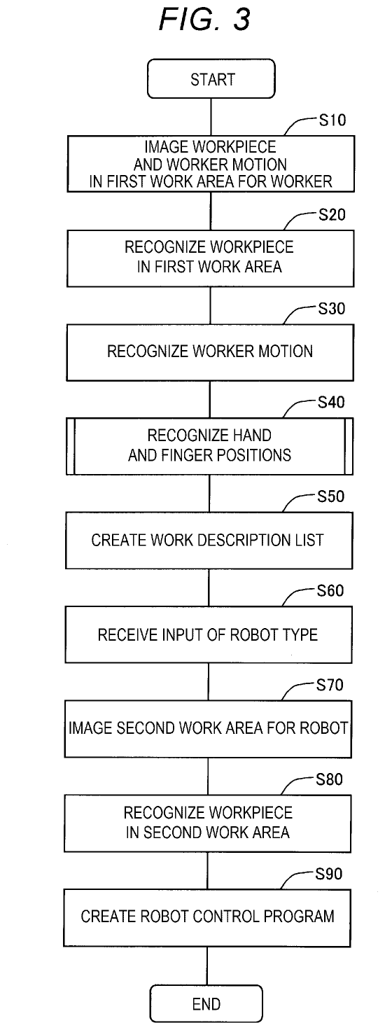

FIG. 3 is a flowchart showing a procedure of the control program creation processing executed by the processor 310. The control program creation processing is started when the worker TP inputs a start instruction of teaching work in the information processing apparatus 300. The following steps S10 to S40 correspond to the teaching work in which the worker TP performs teaching. Note that, in the following description, the simple term “work” refers to work to move a workpiece.

At step S10, the first workpiece WK1 and the motion of the worker TP are imaged in the first work area WA1 using the first camera 210 and the third camera 230. At step S20, the object recognition unit 311 recognizes the first workpiece WK1 in the first work area WA1 from the image captured by the first camera 210 or the third camera 230.

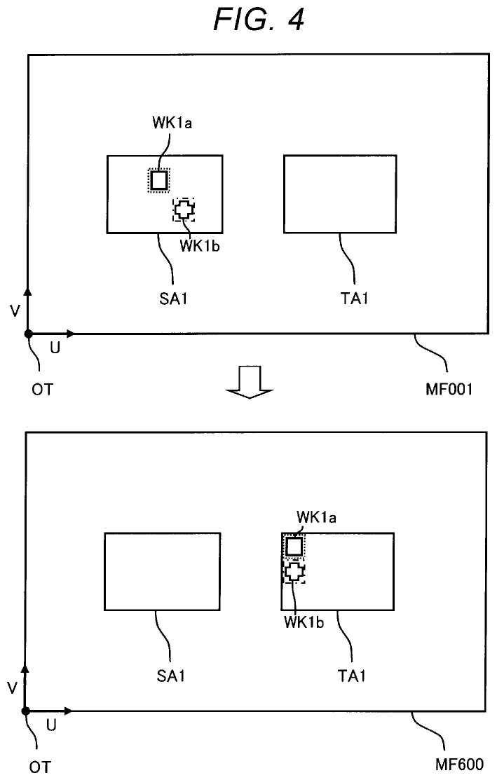

FIG. 4 is an explanatory diagram showing an example of image frames MF001, MF600 obtained by imaging of the first workpiece WK1 within the first work area WA1. The upper image frame MF001 is an image before movement work of the first workpiece WK1 by the worker TP, and the lower image frame MF600 is an image after the movement work of the first workpiece WK1 by the worker TP.

In the image frame MF001 before the movement work, a plurality of first workpieces WK1a, WK1b are placed within the first supply area SA1 and no workpiece is placed in the first target area TA1. In this example, the two types of first workpieces WK1a, WK1b are placed within the first supply area SA1. Note that, as the first workpieces WK1, only one type of component may be used or, for N as an integer equal to or larger than two, N types of components may be used. When the N types of components are used, the workpiece attribute data WD contains data representing the types and the shapes with respect to each of the N types of components. The object recognition unit 311 recognizes the types and the positions and attitudes of the first workpieces WK1a, WK1b from the image frame MF001 with reference to the workpiece attribute data WD. Around these first workpieces WK1a, WK1b, frame lines surrounding the individual workpieces are drawn. These frame lines are changed in color and shape depending on the recognized types of workpieces. The worker TP can distinguish the types of individual workpieces by observing the frame lines drawn around the respective workpieces. Note that these frame lines can be omitted. In the image frame MF001, coordinate axes U, V of an image coordinate system indicating a position within the image frame MF001 are drawn. In the image frame MF600 after the movement work, the plurality of first workpieces WK1a, WK1b move from the first supply area SA1 into the first target area TA1. The object recognition unit 311 also recognizes the types and the positions and attitudes of the first workpieces WK1a, WK1b from the image frame MF600.

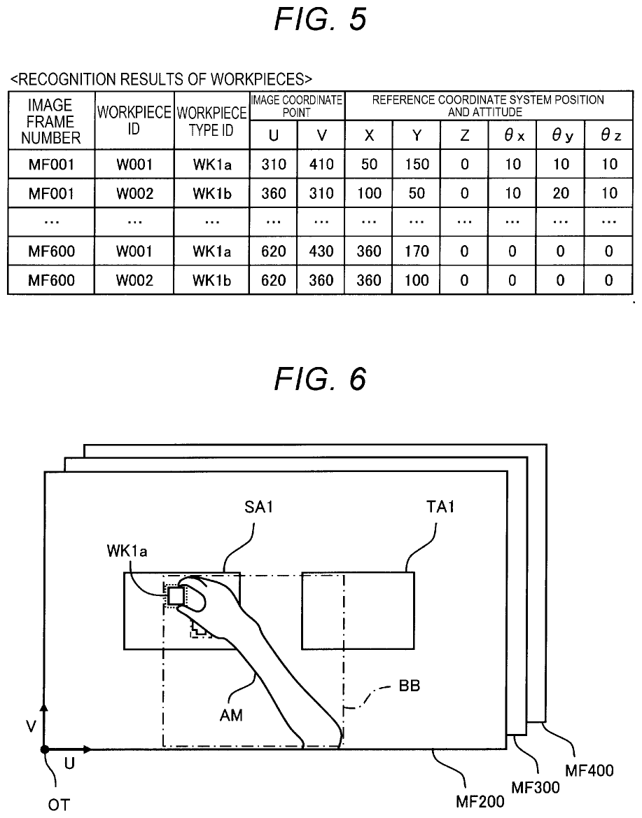

FIG. 5 is an explanatory diagram showing recognition results relating to the first workpieces WK1. In the individual records of the recognition results, image frame numbers, workpiece IDs, workpiece type IDs, image coordinate points, and reference coordinate system positions and attitudes are registered. The recognition results of the workpieces are time-series data in which the records are sequentially arranged on a time-series basis. In the example of FIG. 5, the recognition results of the two first workpieces WK1a, WK1b are registered for the image frame MF001 before the movement work, and the recognition results of the two first workpieces WK1a, WK1b are registered for an image frame MF600 after the movement work. “Work ID” is an identifier for distinction of each workpiece. “Work type ID” is an identifier showing the work type. “Image coordinate point” is a value expressing a representative point of each workpiece by image coordinates (U,V). As the representative point of the workpiece, e.g. a workpiece gravity center point, an upper left point of the frame line surrounding the workpiece shown in FIG. 4, or the like may be used. Note that the image coordinate point may be omitted. “Reference coordinate system position and attitude” are values expressing position and attitude of a workpiece in a reference coordinate system as a robot-independent coordinate system independent of the robot 100. In the present disclosure, the camera coordinate system Σc1 of the first camera 210 is used as the reference coordinate system. Note that another coordinate system may be used as the reference coordinate system. Of the reference coordinate system position and attitude, parameters Ox, Oy, Oz expressing an attitude or rotation respectively show rotation angles around the three axes. As an expression of the parameters expressing an attitude or rotation, any expression such as a rotation matrix or quaternion showing rotation may be used in place of the rotation angle.

The recognition of the workpiece by the object recognition unit 311 is executed when the position and attitude of the workpiece are changed from before the work to after the work, and the recognition results are saved as time-series data. During the work, it is preferable to execute object recognition only when the position and attitude of the workpiece are changed. In this manner, the processing load of the processor 310 may be reduced, and the resource necessary for the processing may be reduced. Note that, when only the position of the object after the work is used in the robot control program, the object recognition by the object recognition unit 311 may be performed only after the work.

At step S30 in FIG. 3, the motion recognition unit 312 recognizes a worker motion from the image captured by the first camera 210.

FIG. 6 is an explanatory diagram showing an example of image frames obtained by imaging of a worker motion. Here, three image frames MF200, MF300, MF400 as part of a plurality of image frames captured on a time-series basis are superimposed. In the image frame MF200, the worker TP extends an arm AM and grips the first workpiece WK1a within the first supply area SA1. The motion recognition unit 312 sets a bounding box BB surrounding the arm AM and the first workpiece WK1a within the image frame MF200. The same applies to the other image frames MF300, MF400.

For example, the bounding box BB may be used for the following purposes.

(1) for contact determination on the image using the recognition result of the workpiece and the recognition result of the hand and finger positions

(2) for specification of the gripping position on the image using the recognition result of the workpiece and the recognition result of the hand and finger positions

(3) for showing that the arm AM is correctly recognized by drawing the bounding box BB in the image

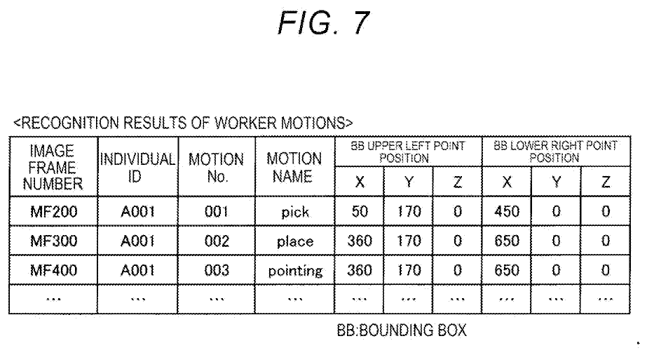

FIG. 7 is an explanatory diagram showing recognition results of worker motions. In the individual records of the recognition results, image frame numbers, individual IDs, motion numbers, motion names, and upper left point positions and lower right point positions of the bounding boxes BB are registered with respect to individual work motions contained in work. The recognition results of worker motions are also time-series data in which the records are sequentially arranged on a time-series basis. “Individual ID” is an identifier for identification of the arm AM. For example, when a right arm and a left arm appear in an image, different individual IDs are assigned. The upper left point position and the lower right point position of the bounding box BB are expressed as positions in the camera coordinate system Σc1 as a reference coordinate system.

“Motion name” shows a type of worker motion in the image frame. In the example of FIG. 7, a pick motion is recognized in the image frame MF200, a place motion is recognized in the image frame MF300, and a pointing motion is recognized in the image frame MF400. These motions may be recognized by analyses of the respective plurality of continuous image frames. Note that the pointing motion refers to a pointing motion using an index finger. The pointing motion may be used for setting of a teaching point in a position on the tip of the index finger and recognition of a workpiece on a straight line extending along a plurality of joints of the index finger as an object to be transported. Another specific motion of the hand and fingers than the above described ones may be used as a motion for instructing a specific motion of the robot. For example, a method of gripping a workpiece may be instructed by a gesture of the hand and fingers.

Note that normal work contains a plurality of worker motions, and the plurality of worker motions are recognized at step S30. Note that work can be configured by one or more worker motions. Therefore, at step S30, one or more worker motions contained in work on a workpiece are recognized.

The recognition processing of the worker motion at step S30 may be executed using “SlowFast Networks for Video Recognition” technique. This technique is a technique of recognizing motions using a first processing result obtained by input of a first image frame group extracted in a first period from the plurality of image frames in a first neural network and a second processing result obtained by input of a second image frame group extracted in a second period longer than the first period from the plurality of image frames in a second neural network. The worker motion may be recognized more accurately using the technique.

At step S40, the hand and finger position recognition unit 313 recognizes the hand and finger positions from the image captured by the first camera 210 or the third camera 230.

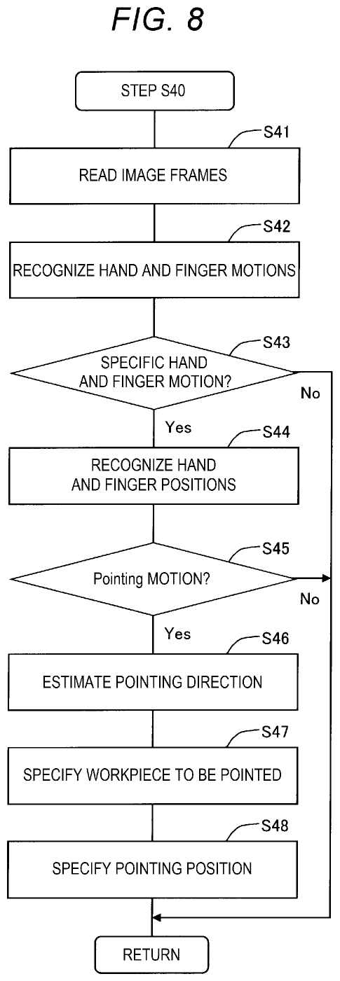

FIG. 8 is a flowchart showing a detailed procedure at step S40. At step S41, the hand and finger position recognition unit 313 reads a plurality of image frames captured by the first camera 210 or the third camera 230. At step S42, the hand and finger position recognition unit 313 recognizes hand and finger motions in the plurality of image frames. At step S43, whether or not the recognized hand and finger motions correspond to a specific hand and finger motion. “Specific hand and finger motion” is a motion with motion of joints of the hand and fingers and designated by the worker TP in advance. As the specific hand and finger motion, for example, a motion including one or more of a gripping motion by hand and fingers, a releasing motion by hand and fingers, and a pointing motion by hand and fingers is designated. In the embodiment, the pick motion corresponds to “gripping motion by hand and fingers”, the place motion corresponds to “releasing motion by hand and fingers”, and the pointing motion corresponds to “pointing motion by hand and fingers”. When the motion of the hand and fingers corresponds to the specific hand and finger motion, at step S44, the hand and finger position recognition unit 313 recognizes hand and finger positions and the process goes to step S45, which will be described later. The recognition results of the hand and finger positions will be described later. When the motion of the hand and fingers does not correspond to the specific hand and finger motion, the processing at step S44 and the subsequent steps is not executed and the processing in FIG. 8 is ended. In other words, when the worker motion does not include the specific hand and finger motion, processing of recognizing the hand and finger positions is not performed. In this manner, the processing of recognizing the hand and finger positions is performed only when the worker motion includes the specific hand and finger motion, and thereby, the processing load may be reduced.

At step S45, whether or not the specific hand and finger motion is a pointing motion is determined. When the specific hand and finger motion is not a pointing motion, the processing in FIG. 8 is ended. On the other hand, when the specific hand and finger motion is a pointing motion, at step S46, the hand and finger position recognition unit 313 estimates a pointing direction from the plurality of image frames. At step S47, the hand and finger position recognition unit 313 specifies a pointed workpiece from the plurality of image frames. At step S48, the hand and finger position recognition unit 313 specifies a pointing position as a position showing a direction of the workpiece specified at step S47. The pointing position is additionally registered in the recognition results of the hand and finger positions. Note that the processing at steps S45 to S48 may be omitted.

FIG. 9 is an explanatory diagram showing recognition of hand and finger positions. Here, in the image frame MF200 shown in FIG. 6, a plurality of reference points JP are specified on the arm AM and the hand and fingers of the worker TP. The plurality of reference points JP are coupled by a link JL. The reference points JP are respectively set in positions of the tips and the joints of the hand and fingers. These reference points JP and the like JL are results of recognition by the hand and finger position recognition unit 313.

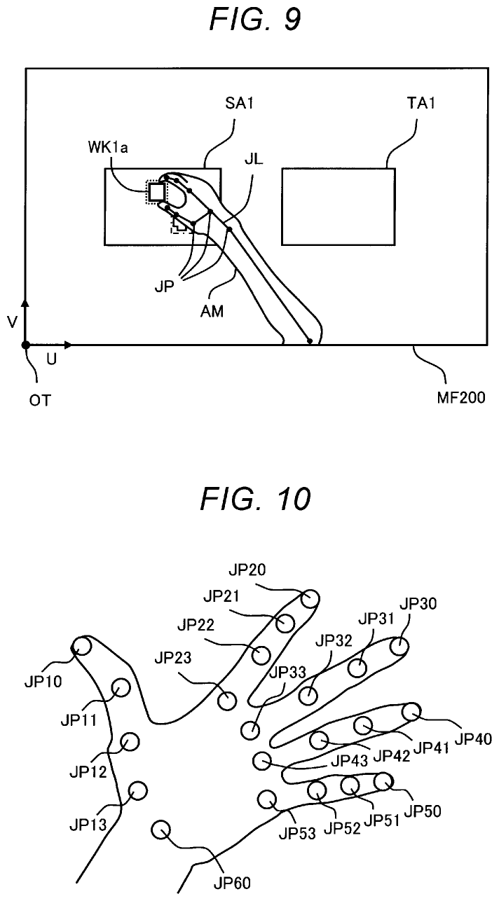

FIG. 10 is an explanatory diagram showing reference points of hand and finger positions to be recognized. Here, as the reference points JP of hand and finger positions to be recognized, the following points are set.

(1) a tip JP10 and joint points JP11 to JP13 of the thumb

(2) a tip JP20 and joint points JP21 to JP23 of the index finger

(3) a tip JP30 and joint points JP31 to JP33 of the middle finger

(4) a tip JP40 and joint points JP41 to JP43 of the third finger

(5) a tip JP50 and joint points JP51 to JP53 of the fifth finger

(6) a joint point JP60 of the wrist

Part or all of these reference points are used as the hand and finger positions recognized by the hand and finger position recognition unit 313. To accurately recognize the hand and finger positions, it is preferable to use all of the above described reference points as objects to be recognized, however, in view of reduction of the processing load, it is preferable to use at least the tip JP10 of the thumb and the tip JP20 of the index finger as objects to be recognized.

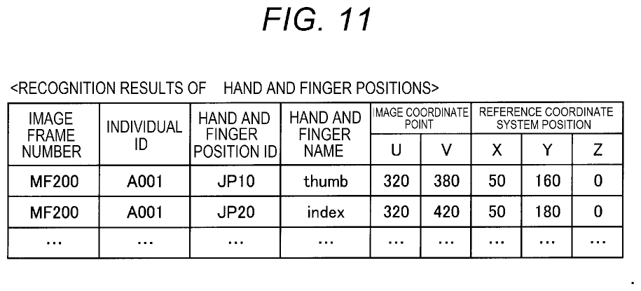

FIG. 11 is an explanatory diagram showing recognition results of the hand and finger positions. In the individual records of the recognition results, image frame numbers, individual IDs, hand and finger position IDs, hand and finger names, image coordinate points of hand and finger positions, and reference coordinate system positions of hand and fingers are registered. The recognition results of the hand and finger positions are also time-series data in which the records are sequentially arranged on a time-series basis. “Individual ID” is an identifier for identification of the arm AM. “Hand and finger position ID” is an identifier for identification of the reference point shown in FIG. 10. As “hand and finger name”, a name of a specific hand or finger to be recognized by the hand and finger position recognition unit 313 is registered. Here, “thumb” and “index” are registered as specific fingers. Regarding “thumb”, the reference point JP10 on the tip thereof is registered and, regarding “index”, the reference point JP20 on the tip thereof is registered. It is preferable that the other reference points shown in FIG. 10 are similarly registered. The image coordinate points and the reference coordinate system positions of hand and fingers show individual hand and finger positions. Note that the image coordinate points may be omitted.

When steps S45 to S48 are executed in the above described FIG. 8 and a pointing position in the pointing motion is specified, the pointing position is additionally registered in the recognition results of the hand and finger positions.

The execution sequence of the above described steps S20 to S40 can be arbitrarily changed. Further, the image used for recognition of the worker motion at step S30 and the image used for recognition of the hand and finger positions at step S40 may be images captured by different cameras. The hand and finger positions are imaged using a camera different from the camera imaging the worker motion, and thereby, the hand and finger positions may be recognized more accurately. Furthermore, the image used for recognition of the worker motion at step S30 and the image used for recognition of the workpiece at step S20 may be images captured by different cameras. The workpiece is imaged using a camera different from the camera imaging the worker motion, and thereby, the workpiece may be recognized more accurately.

At step S50 in FIG. 3, the work description list creation unit 314 creates the work description list WDL using the obtained recognition results. The work description list WDL is time-series data describing work in a robot-independent coordinate system independent of the type of the robot.

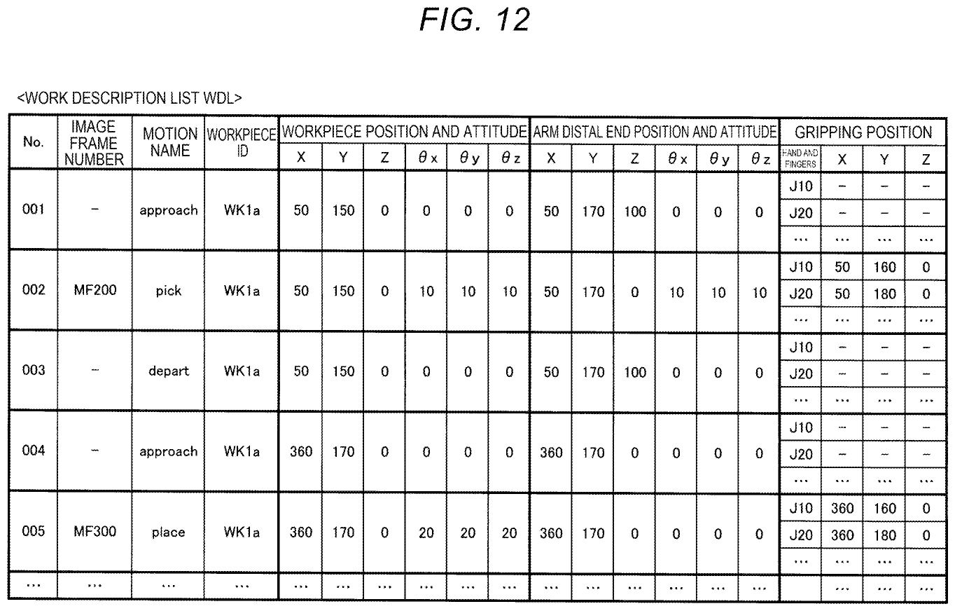

FIG. 12 is an explanatory diagram showing the work description list WDL. In the individual records of the work description list WDL, record numbers, image frame numbers, motion names, workpiece IDs, workpiece positions and attitudes, arm distal end positions and attitudes, and gripping positions are registered with respect to individual motions contained in work. “Motion name” is a type of each motion. In the example of FIG. 12, five motions of “approach”, “pick”, “depart”, “approach”, and “place” are sequentially registered with respect to the same workpiece K1a. The approach motion and the depart motion are not contained in the worker motions described in FIG. 7, but necessary motions as motion commands of the robot control program. Accordingly, the approach motion and the depart motion are added as motions performed before and after the pick motion and the place motion by the work description list creation unit 314.

“Arm distal end position and attitude” are a position and an attitude of the distal end of the robot arm in each motion and calculated from the recognition results of the hand and finger positions shown in FIG. 11. For example, “arm distal end position and attitude” may be determined in the following manner. Regarding the pick motion, a position in which an object and a finger tip contact is obtained as a gripping position from the recognition results of the hand and finger positions when the pick motion is recognized, and coordinate transform with the origin in the reference coordinate system is performed. Then, “arm distal end position and attitude” are calculated as values showing the distal end position of the robot arm from the gripping position. It is preferable to determine the attitude of the arm distal end in consideration of the attitude of the workpiece. The optimal arm distal end position and attitude may be different depending on the end effector used for actual work. For example, the arm distal end position and attitude in the pick motion or the place motion using the gripper can be obtained as the center of gravity of a plurality of gripping positions. The arm distal end position in the approach motion is set to a position at a predetermined distance higher from the arm distal end position in the pick motion or the place motion before and after the approach motion, a position at a predetermined distance to which the hand and finger positions move from positions where the pick motion or the place motion is performed, or a position to which the hand and finger positions move for a predetermined time from the time when the pick motion or the place motion is performed. The same applies to the arm distal end position in the depart motion.

“Gripping position” is hand and finger positions in each motion and calculated from the recognition results of the hand and finger positions shown in FIG. 11. In the example of FIG. 12, the position of the reference point JP10 on the tip of the thumb and the position of the reference point JP20 on the tip of the index finger are registered. The other reference points may be similarly registered, and it is preferable that at least positions with respect to the reference point JP10 on the tip of the thumb and the reference point JP20 on the tip of the index finger are registered. Further, “gripping position” is registered only when the workpiece is gripped by the hand and fingers or gripping of the work piece is released. In the example of FIG. 12, “gripping position” is registered only when the pick motion or the place motion is performed, but “gripping position” is not registered when the approach motion or the depart motion is performed.

All of the positions and attitudes registered in the work description list WDL are expressed in the reference coordinate system as the robot-independent coordinate system. The work description list WDL describes work in the robot-independent coordinate system, and accordingly, a robot control program suitable for any type of robot may be easily created from the work description list WDL. As described above, the work description list WDL is a list in which work is divided in units corresponding to single motions of the robot and the single motion is shown by data in a line. It is preferable that the work description list WDL does not contain a route plan. In other words, it is preferable that only relay points as start points for the robot motions extracted from the worker motions are registered in the work description list WDL.

At step S60 in FIG. 3, the control program creation unit 315 receives input of the robot type. The robot type shows the type of the robot for which the robot control program is created and input by the worker TP.

At step S70, the second work area WA2 for robot is imaged using the second camera 220. At step S80, the object recognition unit 311 recognizes the second workpiece WK2 within the second work area WA2 from the image captured by the second camera 220. At the time, the second workpiece WK2 is placed within the second supply area SA2 in a position before the movement work.

At step S90, the control program creation unit 315 creates the robot control program according to the type of the robot using the work description list WDL created at step S50 and the position of the second workpiece WK2 recognized at step S80. For the creation, as the position of the workpiece before work, the position of the second workpiece WK2 recognized at step S80 is used. Further, as the position of the workpiece after the work, the position of the workpiece after work registered in the work description list WDL is used. Note that, when the second supply area SA2 shown in FIG. 1 is an area in which the position of the second workpiece WK2 is unstable, steps S70, S80 may be omitted and the robot control program may be created without using the position of the second workpiece WK2. In this case, the robot control program is described to pick the workpiece recognized by the second camera 220 when the actual work is executed. Or, when the second supply area SA2 is an area in which the second workpiece WK2 to be picked is placed in a fixed position like a parts feeder, steps S70, S80 may be omitted and the robot control program can be created without using the position of the second workpiece WK2.

In the robot control program, the motions registered in the work description list WDL are transformed into commands and expressions according to the types of robot. Further, in the robot control program RP, the position and the attitude are expressed in the robot coordinate system Σr, and the position and the attitude expressed in the reference coordinate system Σc1 in the work description list WDL are transformed into those in the robot coordinate system Σr by coordinate transform. The transform matrix for coordinate transform from the reference coordinate system Σc1 to the robot coordinate system Σr is known.

To create the robot control program, a correspondence table between the commands of the robot control program languages for various types of robots and details of work may be prepared in advance and registered in the memory 320. In this case, the control program creation unit 315 can execute rule-based processing of selecting a command for the motion registered in the work description list WDL with reference to the correspondence table and performing coordinate transform by providing the position and the attitude registered in the work description list WDL as parameters.

In the work description list WDL shown in FIG. 12, a gripping position by a plurality of fingers is registered as “gripping position” and, when the actually used end effector has a plurality of fingers for gripping the workpiece, the positions of those fingers can be described by the robot control program. Or, when the actually used end effector does not have any finger, but is e.g. a suction hand for suctioning the workpiece, the position and the attitude of the end effector can be described without using “gripping position”, but using “arm distal end position and attitude”. As understood from these examples, in the embodiment, “arm distal end position and attitude” and “gripping position” are described in the work description list WDL, and thereby, the robot control program suitable for the robot and the end effector actually used can be created.

As described above, in the above described embodiment, since the hand and finger positions are recognized when the worker motion contains the specific hand and finger motion with motion of joints of the hand and fingers, the processing load may be reduced compared to a case where the hand and finger positions are recognized on a regular basis. Further, in the above described embodiment, the work description list WDL describing work in the robot-independent coordinate system is created, then, the robot control program RP suitable for the type of robot is created from the work description list WDL, and thereby, a control program for execution of work using one of a plurality of types of robots may be easily created. Note that the robot control program RP may be created from the recognition results of the worker motions, the recognition results of the hand and finger positions, and the recognition results of the workpieces without creating the work description list WDL.

Note that, in the above described embodiment, the example of the pick-and-place work is explained, however, the present disclosure can be applied to other work. For example, the present disclosure may be applied to various kinds of work including painting work containing pointing motion, screwing work, nailing work with a hammer, insertion work of workpieces, fitting work, and assembly work.

### OTHER EMBODIMENTS

The present disclosure is not limited to the above described embodiments, but may be realized in various aspects without departing from the scope thereof. For example, the present disclosure can be realized in the following aspects. The technical features in the above described embodiments corresponding to the technical features in the following respective aspects can be appropriately replaced or combined to solve part or all of the problems of the present disclosure or achieve part or all of the effects of the present disclosure. The technical features not described as essential features in this specification can be appropriately deleted.

(1) According to a first aspect of the present disclosure, a computer program for a processor to execute processing of creating a control program for a robot is provided. The computer program controls the processor to execute (a) processing of recognizing a worker motion from an image of one or more worker motions contained in work to operate a workpiece by a worker using an arm and a hand and fingers, the image captured by an imaging apparatus, (b) processing of recognizing hand and finger positions in a specific hand and finger motion with motion of joints of the hand and fingers from an image of the hand and fingers captured by the imaging apparatus when the worker motion contains the specific hand and finger motion, (c) processing of recognizing a position of the workpiece after the work from an image of the workpiece captured by the imaging apparatus, and (d) processing of generating the control program for the robot using the worker motion recognized in the processing (a), the hand and finger positions recognized in the processing (b), and the position of the workpiece recognized in the processing (c).

(2) In the above described computer program, the specific hand and finger motion may include one or more of a gripping motion by the hand and fingers, a releasing motion by the hand and fingers, and a pointing motion by the hand and fingers, and, in the processing (b), processing of recognizing the hand and finger positions may not be performed when the worker motion does not contain the specific hand and finger motion.

According to the computer program, the processing of recognizing the hand and finger positions is performed only when the worker motion contains the specific hand and finger motion, and the creating processing of the robot control program may be executed at a higher speed.

(3) In the above described computer program, the processing (d) may include (i) processing of creating a work description list describing the work in a robot-independent coordinate system independent of a type of the robot using the worker motion, the hand and finger positions, and the position of the workpiece, and (ii) processing of creating the control program using the work description list according to the type of the robot controlled by the control program.

According to the computer program, the work description list describing the work in the robot-independent coordinate system is created, then, the control program suitable for the type of the robot is created from the work description list, and thereby, the robot control program for execution of the work using one of a plurality of type of robots may be easily created.

(4) In the above described computer program, the imaging apparatus may include a plurality of cameras, and the image used for recognition of the worker motion in the processing (a) and the image used for recognition of the hand and finger positions in the processing (b) may be images captured by different cameras.

According to the computer program, the hand and finger positions are imaged using another camera than the camera imaging the worker motion, and thereby, the hand and finger positions may be recognized more accurately.

(5) In the above described computer program, the imaging apparatus may include a plurality of cameras, and the image used for recognition of the worker motion in the processing (a) and the image used for recognition of the position of the workpiece in the processing (c) may be images captured by different cameras.

According to the computer program, the workpiece is imaged using another camera than the camera imaging the worker motion, and thereby, the position of the workpiece may be recognized more accurately.

(6) In the above described computer program, the image captured by the imaging apparatus may contain a plurality of image frames, and the processing (a) may be processing of recognizing the worker motion using a first processing result obtained by input of a first frame group extracted from the plurality of image frames in a first period in a first neural network, and a second processing result obtained by input of a second frame group extracted from the plurality of image frames in a second period longer than the first period in a second neural network.

According to the computer program, the worker motion may be recognized more accurately.

(7) According to a second embodiment of the present disclosure, a method of creating a control program for a robot is provided. The method includes (a) recognizing a worker motion from an image of one or more worker motions contained in work to operate a workpiece by a worker using an arm and a hand and fingers, the image captured by an imaging apparatus, (b) recognizing hand and finger positions in a specific hand and finger motion with motion of joints of the hand and fingers from an image of the hand and fingers captured by the imaging apparatus when the worker motion contains the specific hand and finger motion, (c) recognizing a position of the workpiece after the work from an image of the workpiece captured by the imaging apparatus, and (d) generating the control program for the robot using the worker motion recognized at (a), the hand and finger positions recognized at (b), and the position of the workpiece recognized at (c).

According to the method, the hand and finger positions are recognized when the worker motion contains the specific hand and finger motion with motion of joints of the hand and fingers, and thereby, the processing load may be reduced compared to a case where the hand and finger positions are recognized on a regular basis.

(8) According to a third embodiment of the present disclosure, a system executing processing of creating a control program for a robot is provided. The system includes an information processing apparatus having a processor, and an imaging apparatus coupled to the information processing apparatus. The processor executes (a) processing of recognizing a worker motion from an image of one or more worker motions contained in work to operate a workpiece by a worker using an arm and a hand and fingers, the image captured by the imaging apparatus, (b) processing of recognizing hand and finger positions in a specific hand and finger motion with motion of joints of the hand and fingers from an image of the hand and fingers captured by the imaging apparatus when the worker motion contains the specific hand and finger motion, (c) processing of recognizing a position of the workpiece after the work from an image of the workpiece captured by the imaging apparatus, and (d) processing of generating the control program for the robot using the worker motion recognized in the processing (a), the hand and finger positions recognized in the processing (b), and the position of the workpiece recognized in the processing (c).

According to the system, the hand and finger positions are recognized when the worker motion contains the specific hand and finger motion with motion of joints of the hand and fingers, and thereby, the processing load may be reduced compared to a case where the hand and finger positions are recognized on a regular basis.

The present disclosure can be realized in other various aspects than those described as above. For example, the present disclosure may be realized in aspects of a robot system including a robot and a robot control apparatus, a computer program for realizing functions of the robot control apparatus, a non-transitory storage medium in which the computer program is recorded, etc.

What is claimed is:

1. A non-transitory computer-readable storage medium storing a computer program, the computer program controlling a processor to execute processing of creating a control program for a robot, comprising:
(a) processing of recognizing a worker motion from an image of one or more worker motions contained in work to operate a workpiece by a worker using an arm and a hand and fingers, the image captured by an imaging apparatus;
(b) processing of recognizing hand and finger positions in a specific hand and finger motion with motion of joints of the hand and fingers from an image of the hand and fingers captured by the imaging apparatus when the worker motion contains the specific hand and finger motion;
(c) processing of recognizing a position of the workpiece after the work from an image of the workpiece captured by the imaging apparatus; and
(d) processing of generating the control program for the robot using the worker motion recognized in the processing (a), the hand and finger positions recognized in the processing (b), and the position of the workpiece recognized in the processing (c).

2. The non-transitory computer-readable storage medium storing the computer program according to claim 1, wherein
the specific hand and finger motion includes one or more of a gripping motion by the hand and fingers, a releasing motion by the hand and fingers, and a pointing motion by the hand and fingers, and
in the processing (b), processing of recognizing the hand and finger positions is not performed when the worker motion does not contain the specific hand and finger motion.

3. The non-transitory computer-readable storage medium storing the computer program according to claim 1, wherein
the processing (d) includes:
(i) processing of creating a work description list describing the work in a robot-independent coordinate system independent of a type of the robot using the worker motion, the hand and finger positions, and the position of the workpiece; and
(ii) processing of creating the control program using the work description list according to the type of the robot controlled by the control program.

4. The non-transitory computer-readable storage medium storing the computer program according to claim 1, wherein
the imaging apparatus includes a plurality of cameras, and
the image used for recognition of the worker motion in the processing (a) and the image used for recognition of the hand and finger positions in the processing (b) are images captured by different cameras.

5. The non-transitory computer-readable storage medium storing the computer program according to claim 1, wherein
the imaging apparatus includes a plurality of cameras, and
the image used for recognition of the worker motion in the processing (a) and the image used for recognition of the position of the workpiece in the processing (c) are images captured by different cameras.

6. The non-transitory computer-readable storage medium storing the computer program according to claim 1, wherein
the image captured by the imaging apparatus contains a plurality of image frames, and
the processing (a) is processing of recognizing the worker motion using a first processing result obtained by input of a first frame group extracted from the plurality of image frames in a first period in a first neural network, and a second processing result obtained by input of a second frame group extracted from the plurality of image frames in a second period longer than the first period in a second neural network.

7. A method of creating a control program for a robot comprising:
(a) recognizing a worker motion from an image of one or more worker motions contained in work to operate a workpiece by a worker using an arm and a hand and fingers, the image captured by an imaging apparatus;
(b) recognizing hand and finger positions in a specific hand and finger motion with motion of joints of the hand and fingers from an image of the hand and fingers captured by the imaging apparatus when the worker motion contains the specific hand and finger motion;
(c) recognizing a position of the workpiece after the work from an image of the workpiece captured by the imaging apparatus; and
(d) generating the control program for the robot using the worker motion recognized at (a), the hand and finger positions recognized at (b), and the position of the workpiece recognized at (c).

8. A system executing processing of creating a control program for a robot, comprising:
an information processing apparatus having a processor; and
an imaging apparatus coupled to the information processing apparatus,
the processor executing
(a) processing of recognizing a worker motion from an image of one or more worker motions contained in work to operate a workpiece by a worker using an arm and a hand and fingers, the image captured by the imaging apparatus,
(b) processing of recognizing hand and finger positions in a specific hand and finger motion with motion of joints of the hand and fingers from an image of the hand and fingers captured by the imaging apparatus when the worker motion contains the specific hand and finger motion,
(c) processing of recognizing a position of the workpiece after the work from an image of the workpiece captured by the imaging apparatus, and
(d) processing of generating the control program for the robot using the worker motion recognized in the processing (a), the hand and finger positions recognized in the processing (b), and the position of the workpiece recognized in the processing (c).
